(19) United States
(12) Patent Application Publication
(10) Pub. No.: US 2004/0020340 A1
(43) Pub. Date: Feb. 5, 2004

(54) Book trimmer and trimmer blade

(75) Inventors: Timothy Andrew Burke, Halifax (CA); David Robert Dawley, Rochester, NH (US); Drew Edwin Kiefaber, Newmarket, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Heidelberger Druckmaschinen AG, Heidelberg (DE)

(21) Appl. No.: 10/208,551

(22) Filed: Jul. 30, 2002

(51) Int. Cl. B26D 5/08; B26D 7/28; B26D 1/00

(52) U.S. Cl. 83/613; 83/639.1; 83/651; 83/934

(57) ABSTRACT

A trimmer for trimming of a book has a support for supporting the book, a trim blade for trimming an edge of the book, and a reciprocating actuator for moving the trim blade toward the book to trim the edge of the book. The trim blade has a trim blade edge having a first section and a second section, the second section being angled with respect to the first section.

### BACKGROUND OF THE INVENTION

The present invention relates generally to printed materials and more particularly to trimming units for trimming edges of a book.

U.S. application Ser. No. 2002/0034428 discloses a trimmer for trimming excess margins along one, two or three edges of a perfect bound book. The book is gripped by a book holder, and a shearing blade cuts the edges of the book. The shearing blade has a flat edge and reciprocates.

European Patent Application No. 1 201 379 discloses a three-sided trimmer having a top edge cutting knife, a bottom edge cutting knife and a fore edge cutting knife, all with flat edges and reciprocating.

European Patent Application No. 0 893 277 discloses a trimmer, particularly for trimming book backs. A milling cutter has a disc-shaped body specially shaped teeth. The trimmer is a rotary cutter.

### BRIEF SUMMARY OF THE INVENTION

A problem associated with prior art trimmers used for trimming books is the delamination of the cover of a book from the interior sheet material. This trim defect is typically called “chipout”.

FIGS. 1 and 2 show a force vector analysis by the present inventors, in which the forces of a straight trim blade at an angle alpha are analyzed as a trimming blade 10 with a straight edge 12 cuts an end of a book 20. Book 20 includes sheet material 26 and a cover 22, connected to sheet material 26 by adhesive 24.

A resultant force FR normal to the blade edge 12 results, with a force component F1 parallel to a tangent line of the cover interaction with the sheet material 26, and a component FN normal to the tangent line. As shown in FIG. 1, as the blade 12 first cuts at the top of the book 26 and cover 22, the normal force FN is directed into the book. At this stage, generally no chipout occurs.

However, as shown in FIG. 2, as the cut progresses through the lower curved section 28 of cover 22, the normal force FN acting on cover 22 is directed away from sheet material 26, and can cause chipout, since the force is directed away from the sheet material 26.

An object of the present invention is to improve cutting of books, especially of the sides of books adjacent to the spine. Another alternate or additional object of the present invention is to reduce chipout in reciprocating blade trimmers.

The present invention provides a trimmer for trimming a book comprising:

a support for supporting a book;

a trim blade for trimming an edge of the book, the trim blade having a trim blade edge, the trim blade edge having a first section and a second section, the second section being angled with respect to the first section; and

a reciprocating actuator for moving the trim blade toward the book to trim an edge of the book.

By having a trim blade used in a reciprocating movement (as opposed to rotary blades) with different angled sections, the forces causing chipout can be minimized, while still maintaining a desired resultant force for cutting the sheet material. With a straight trim blade edge, an attempt to minimize chipout solely by angling the straight blade edge could result in a force on the sheet material that could cause the sheets to move with respect to one another or otherwise be damaged. The two section blade edge of the present invention advantageously permits one angle for cutting the spine section of the book, and another for cutting the sheet material and cover away from the spine.

Preferably, the support has a support surface and supports the book so that a plane of the spine is perpendicular to the support surface and the first section cuts through the spine and the second section cuts the rest of the book.

The first section preferably forms an acute angle theta 1 with the support surface. The second section may form an angle theta 2 with the support surface, and theta 2 may be between zero and 30 degrees for example.

If the trim blade moves at a direction normal to the support surface, angle theta 1 preferably is between 30 and 60 degrees, and most preferably about 45 degrees, although other angles are possible.

If the trim blade moves at an angle gamma 1 toward the spine with respect to a plane of the spine, the angle theta 1 added to the angle gamma 1 preferably is between 30 and 60 degrees, and most preferably about 45 degrees, although other angles are possible.

In this way, the forces causing chipout can be minimized while providing an efficient cut.

The present invention also provides a trim blade for reciprocal trimming of an edge of the book, the trim blade comprising a trim blade body having a trim blade edge, the trim blade edge having a first section for cutting a spine section of the book and a second section for cutting a rest of the book, the second section being angled with respect to the first section. Preferably, the angle of the first section with respect to the second section (gamma 2=theta 1 minus theta 2) is at least 15 degrees, although other angles are possible.

### BRIEF DESCRIPTION OF THE DRAWINGS

FIG. 1 shows a force analysis of a prior art blade edge cutting through a top section of a book spine; and

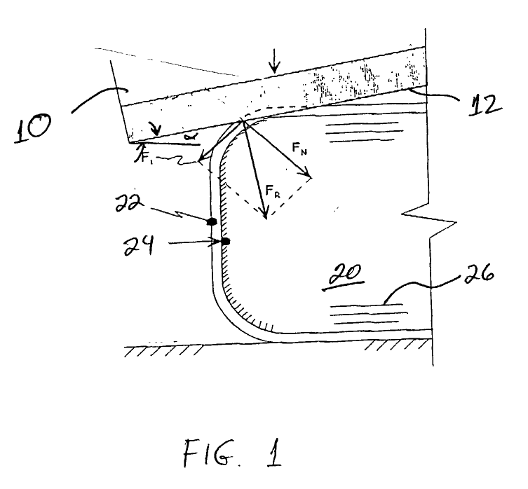

FIG. 2 shows a force analysis of a prior art blade edge cutting through the bottom of the book spine of FIG. 1.

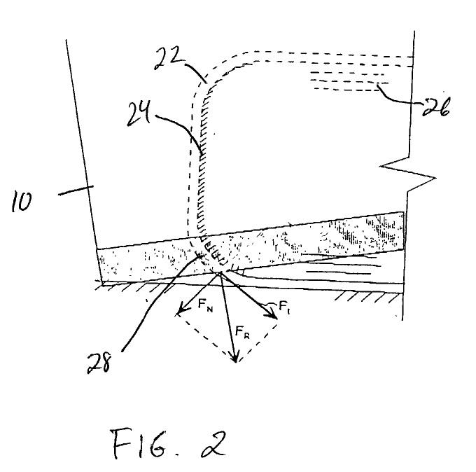

Two preferred embodiments of the trimmer of the present invention are described below by reference to the following drawings, in which:

FIG. 3 shows one embodiment of a trimmer according to the present invention;

FIG. 4 shows a second embodiment of a trimmer according to the present invention;

FIG. 5 shows a schematic end view of trimmer in FIG. 3 as viewed from A-A; and

FIG. 6 shows a force analysis of the trim blade of the present invention at a lower section of the book spine.

### DETAILED DESCRIPTION OF THE PREFERRED EMBODIMENTS

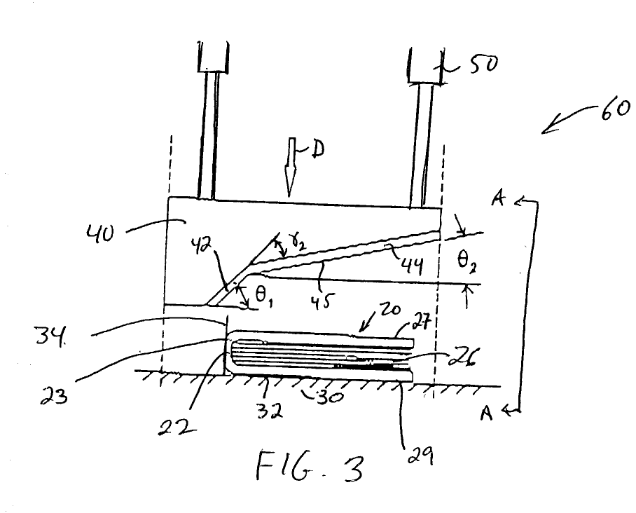

FIG. 3 shows a first embodiment of an edge trimmer 60. A reciprocating actuator 50, for example with two mechanically driven rods, is connected to a trim blade 40. Actuator 50 moves trim blade 40 in direction D, which is normal to a support surface 32 of a support 30, which supports book 20.

Book 20 is supported on support surface 32 on one side 29, and an other side 27 faces the trim blade 40. Cover 22 for sheet material 26 covers one side of the sheet material so as to define a spine 23.

Spine 23 defines a spine plane 34 which is perpendicular to support surface 32. 31

Trim blade 40 has a blade edge 45 for cutting book 20, with blade edge 45 having a first section 42 for cutting spine 23 and a second section for cutting the rest of book 20.

First blade section 42 forms an angle theta 1 with respect to support surface 32, and second blade section 44 forms a different angle theta 2 with respect to support surface 32, angle theta 1 being greater than angle theta 2. Thus an angle gamma 2 is defined between first section 42 and second section 44. Angle gamma 2 is not zero, and is positive. In other words angle theta 1 is greater than angle theta 2.

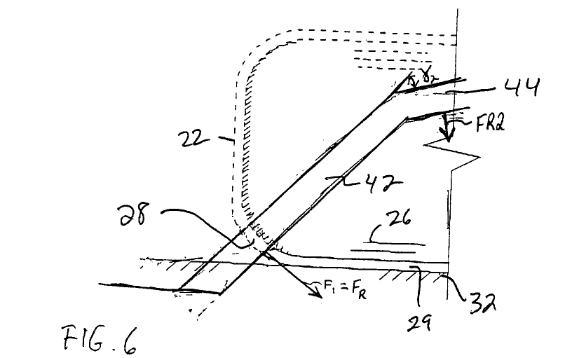

As shown in FIG. 6, the resultant force FR at lower curved section 28 at some point equal to the force F1 tangent to the interaction of the cover 22 with sheet material 26, and the normal force FN is zero. Prior to this point during cutting, the normal force FN is directed into the sheet material. While a small normal force on the cover 22 directed away from the sheet material 26 may result after this point, as curved section 28 connects with side 29, this normal force is small. In addition, edge section 44 still cuts with a force FR2 that is mainly normal to surface 32, which provides better cutting and less chance that sheet material 26 will form wrinkles or other problems associated with forces in the same plane as sheet material 26.

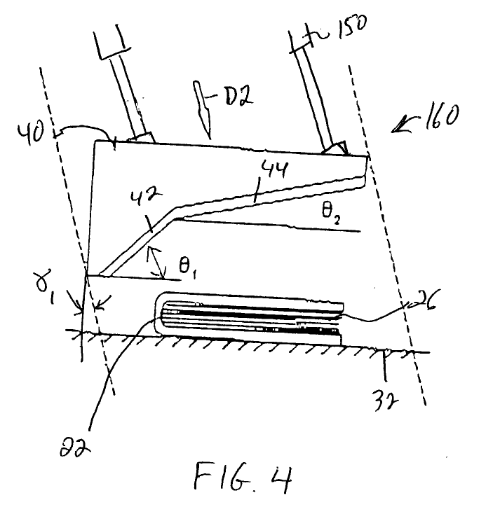

FIG. 4 shows a second embodiment of a trimmer 160 with an actuator 150 that moves the trim blade 40 in direction D2 at an angle gamma 1 with respect to support surface 32. In this case, the forces causing chip out are further compensated for by the angle gamma 1.

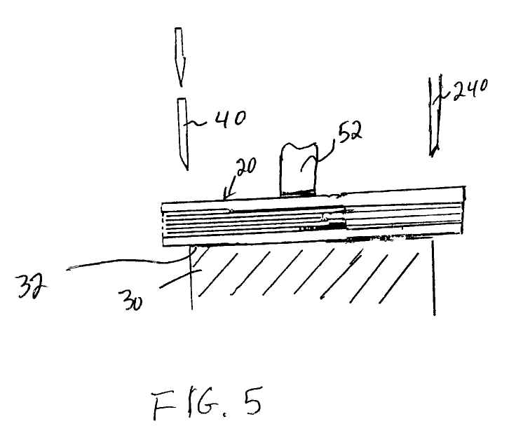

FIG. 5 shows a schematic end view of trimmer in FIG. 3 as viewed from A-A. Support surface 30 ends so that trim blade 40 can cut fully through book 20. A clamp 52 can hold book 20 firmly during the cutting procedure.

Trimmers 60, 160 may include a second trim blade 240 parallel to trim blade 40, for cutting the other side of book 20 perpendicularly to spine 23, and second trim blade 240 may be similarly shaped to trim blade 40.

“Book” as defined herein may be any collection of sheet material with a spine. Angled as defined herein means that an angle greater than zero exists. However, an acute angle as defined herein may be zero. “Reciprocating” as defined herein means a back and forth non-rotating movement, and may include back and forth movement along a straight or curved line.

What is claimed is:

1. A trimmer for trimming of a book comprising:
a support for supporting the book;
a trim blade for trimming an edge of the book, the trim blade having a trim blade edge, the trim blade edge having a first section and a second section, the second section being angled with respect to the first section; and
a reciprocating actuator for moving the trim blade toward the book to trim the edge of the book.

2. The trimmer as recited in claim I wherein the support has a support surface and supports the book so that a plane of a spine of the book is perpendicular to the support surface, the first section cutting through the spine and the second section cutting a rest of the book.

3. The trimmer as recited in claim 2 wherein the first section forms a first acute angle with the support surface and the second section forms a second acute angle with the support surface, the first acute angle being nonzero and being greater than the second acute angle.

4. The trimmer as recited in claim 2 wherein the first angle is between 30 and 60 degrees.

5. The trimmer as recited in claim 4 wherein the first angle is 45 degrees.

6. The trimmer as recited in claim 1 wherein the actuator moves the trim blade in a direction parallel to a plane of a spine of the book.

6. The trimmer as recited in claim 4 wherein the actuator moves the trim blade in a direction parallel to a plane of a spine of the book.

7. The trimmer as recited in claim 1 wherein the actuator moves the trim blade at a cut angle with respect to the spine of the book, the first angle added to the cut angle being between 30 and 60 degrees.

8. The trimmer as recited in claim 7 wherein the first angle added to the cut angle being 45 degrees.

9. The trimmer as recited in claim 1 wherein the first section is angled with respect to the book by a first angle theta 1 and the second section by a second angle theta 2, a difference theta 1 minus theta 2 being more than 15 degrees.

10. A trim blade for reciprocal trimming of a book, the trim blade comprising:
a trim blade body having a trim blade edge, the trim blade edge having a first section angled with respect to a side of the book by a first angle and a second section angled with respect to the side of the book by a second angle,
the first angle being larger than the second angle.

11. The trim blade as recited in claim 10 wherein the first angle is larger than the second angle by at least 15 degrees.
